(19) United States
(12) Patent Application Publication
(10) Pub. No.: US 2007/0165670 A1
(43) Pub. Date: Jul. 19, 2007

(54) Base station and wireless terminal

(76) Inventors: Yukimasa Nagai, Tokyo (JP); Akinori Fujimura, Tokyo (JP); Hiroaki Hirai, Tokyo (JP); Hiroyoshi Suga, Tokyo (JP)

Correspondence Address: BIRCH STEWART KOLASCH & BIRCH, PO BOX 747, FALLS CHURCH, VA, 22040-0747, US

(21) Appl. No.: 10/557,004

(22) PCT Filed: Jun. 3, 2004
(86) PCT No.: PCT/JP04/08054

§ 371 Date: Oct. 6, 2006

(30) Foreign Application Priority Data
Jun. 4, 2003 (JP) 2003-159776

(51) Int. Cl. H04J 3/16

(52) U.S. Cl. 370/470

(57) ABSTRACT

A combination-information creating unit creates combination information for determining a maximum number of combinations or a maximum frame length according to a usable radio band and a modulation method and combination possibility information for indicating that a combination of frames is possible. A frame combining unit combines a plurality of frames received from an outside access line, based on the combination information, the combination possibility information, and predetermined packet information. A frame dividing unit divides a combined frame included in a received radio signal into individual frames.

### TECHNICAL FIELD

The present invention relates to a base station and a wireless terminal that exchange radio signals based on a wireless local-area-network (LAN) standards IEEE802.11, and more particularly, to a base station and a wireless terminal that employ carrier sense multiple access/collision avoidance (CSMA/CA) as a wireless access method.

### BACKGROUND ART

Hereinafter, a conventional wireless communication system (wireless LAN communication system) will be explained. As an equipment to build a high-speed wireless network system for home and office, a commercial product based on the standards of IEEE802.11b and IEEE802.11a, etc., standardized based on the wireless LAN standards IEEE802.11 of the United States of America is currently marketed (see Non-patent document 1). In such a wireless network system, the communication speed can be increased by a broad bandwidth, a multiple-valued modulation, and an increase in the number of antennas.

A wireless LAN based on the IEEE802.11b standards uses a 2.4-GHz band and complementary code keying (CCK) as a modulation method and realizes a maximum physical transmission rate of 11 Mbps (see Non-patent document 2). In addition, a wireless LAN based on the IEEE802.11a standards uses a 5-GHz band and orthogonal frequency-division-multiplexing (OFDM) as a modulation method and realizes a maximum physical transmission rate of 54 Mbps (see Non-patent document 3). A wireless LAN based on the IEEE802.11g standards, of which the specification is currently under consideration, uses a 2.4 GHz band and OFDM as a modulation method and realizes a maximum physical transmission rate of 54 Mbps.
Non-patent document 1: IEEE802.11 (http://standards.ieee.org/getieee802/802.11.html)
Non-patent document 2: IEEE802.11b
Non-patent document 3: IEEE802.11a

However, in the conventional wireless network systems, for example, when a base station and a plurality of wireless terminals exchange radio signals based on the IEEE802.11 standards and the base station makes a connection to outside of the system through an access line such as an Ethernet (R), the maximum data length to be transmitted from the access line to the base station is limited to 1500 bytes. In addition, because the base station is connected to the access line (Ethernet (R)), when the wireless terminals are connected to the base station, each of the wireless terminals must transmit data by setting the maximum data length to 1500 bytes.

Therefore, even when the wireless bandwidth is broadened to increase the communication speed, because an idling period between frames for carrier sensing in CSMA/CA (carrier sense multiple access/collision avoidance) and a wireless frame response (ACK, NAK) processing period exist, and the proportion of the Frame-Body (data) transmitting period is reduced by overhead of a header, etc., in the physical layer, an increase in effective communication speed according to the bandwidth cannot be expected. Furthermore, because the data length (frame length) is limited, the effective throughput is considerably decreased.

The present invention is made in view of the above circumstances, and an object thereof is to obtain a base station and a wireless terminal that can avoid considerable decrease in the effective throughput due to the frame length limitation, and can eliminate the idling period between frames for carrier sensing in CSMA/CA, the wireless frame response (ACK, NAK) transmitting period, and the overhead of a header, etc., in a physical layer.

### DISCLOSURE OF INVENTION

To solve the above problems and to achieve the object, a base station according to the present invention base station, which makes up a wireless local-area-network system, being configured to be connected to an outside access line, includes a combination-information creating unit (corresponding to a radio unit 15 in exemplary embodiments) that transmits and receives a radio signal within the wireless local-area-network system, and creates combination information for determining a maximum number of combinations or a maximum frame length according to a usable radio band and a modulation method and combination possibility information for indicating that a combination of frames is possible; a frame combining unit (corresponding to a frame combining unit 31, 31a in an interface unit 14) that combines a plurality of frames received from the outside access line, based on the combination information, the combination possibility information, and predetermined packet information; and a frame dividing unit (corresponding to a frame dividing unit 32, 32a in the interface unit 14) that divides, when the radio signal is received, a plurality of frames combined by an apparatus on other side of communication.

According to the present invention, for example, a base station that builds a wireless network for home and office properly combines and transmits a plurality of frames received from the outside based on the combination information, the combination possibility information, and predetermined packet information, and properly divides frames that are combined on a receiving-side. In addition, when the CSMA/CA is used and an access to media is impossible for a predetermined time and there is some time until the next access, a processing of combining received frames is continued until the next access timing.

### BRIEF DESCRIPTION OF DRAWINGS

FIG. 1 is a schematic of a configuration of a wireless communication system including a base station and wireless terminals according to the present invention;

FIG. 2 is a schematic of an example of a configuration of an interface unit between the base station and the wireless terminal according to the present invention;

FIG. 3 is a schematic of a data frame format;

FIG. 4 is a schematic of an example of a transmitting side Shared-Memory inside a Shared-Memory according to a first embodiment of the present invention;

FIG. 5 is a flowchart of a processing procedure for a frame combining unit;

FIG. 6 is a schematic of an example of a receiving-side Shared-Memory inside the Shared-Memory according to the first embodiment;

FIG. 7 is a flowchart of a processing procedure for a frame dividing unit;

FIG. 8 is a schematic of a configuration of a frame combining unit according to a second embodiment of the present invention; and

FIG. 9 is a schematic of a configuration of a frame dividing unit according to the second embodiment.

### BEST MODE(S) FOR CARRYING OUT THE PRESENT INVENTION

Exemplary embodiments of a base station and a wireless terminal according to the present invention will explained in detail below with reference to the accompanying drawings. The present invention is not limited to these embodiments.

### First Embodiment

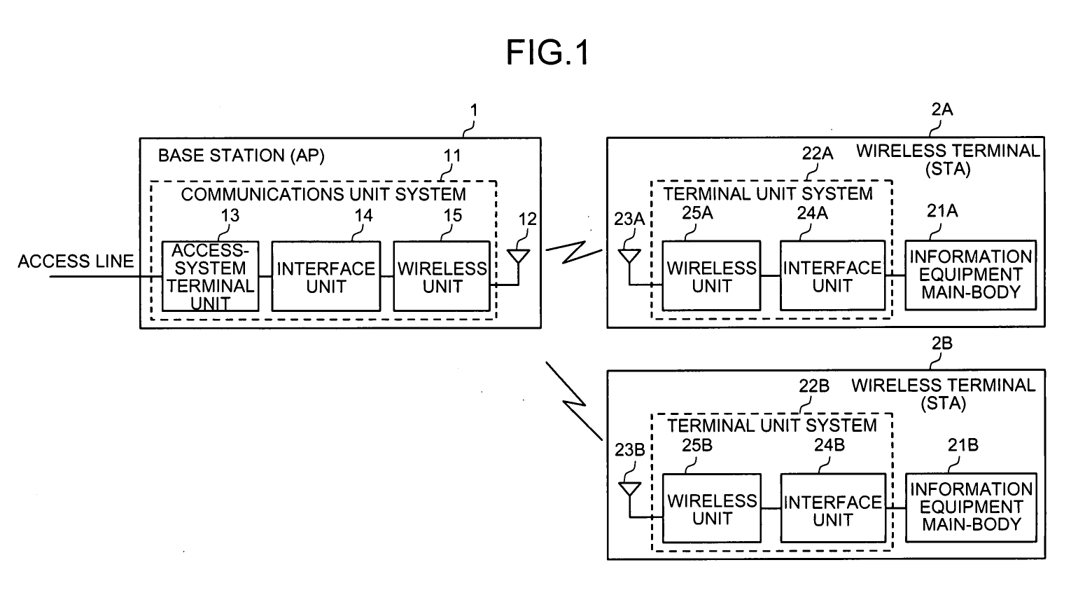

FIG. 1 is a schematic of a configuration of a wireless communication system (home/office wireless network) including a base station and wireless terminals according to the present invention. The wireless communication system includes a base station (AP) 1 having a gateway for relative connection to an access line (such as, Ethernet (R), xDSL, CATV, FTTH) to be connected to a wired or wireless outside communication network and a plurality of wireless terminals (STA) 2A, 2B . . . , which carry out receiving processing of data from the access line and processing of transmission to the access line. Between the base station 1 and the wireless terminals, radio signal transmission and receiving processing based on IEE802.11b and IEEE802.11a standards standardized based on the wireless LAN standards IEEE802.11 of the USA is carried out.

The base station 1 includes a communication unit system 11 that terminates the wired or wireless access line, transmits received data from the access line to specific wireless terminals 2A, 2B . . . via the home/office wireless network, and on the other hand, transmits received data from the wireless terminals 2A and 2B . . . to the access line side. The communication unit system 11 includes an access-system terminal unit 13 that terminates the access line, an interface unit 14 (corresponding to, for example, router, bridge) that controls relative signal format conversion between signals on the access line and signals of the home/office wireless terminals 2A, 2B . . . and further controls a memory (corresponding to a Shared-Memory 33 described later) and the like, a wireless unit 15 that carries out transmission and receiving processing of radio signals based on the IEEE802.11a, IEEE802.11b, and the IEEE802.11g standards, etc., in the home/office wireless network, and an antenna 12.

The wireless terminals 2A and 2B include information equipment main-bodies 21A and 21B such as a personal computer, a personal digital assistant (PDA), a television, and terminal unit systems 22A and 22B that control data transmission and receiving between the information equipment main-bodies 21A and 21B and the communication unit system 11 of the base station 1, respectively. The terminal unit systems 22A and 22B include interface units 24A and 24B that control relative signal format conversion between signals of the base station 1 and other wireless terminals and signals of the information equipment main-bodies 21A and 21B and controls a memory (corresponding to the Shared-Memory 33 described later) and the like, wireless units 25A and 25B that carry out radio signal transmission and receiving processing based on the IEEE802.11a, IEEE802.11b, and IEEE802.11g standards in the home/office wireless network, and antennas 23A and 23B, respectively.

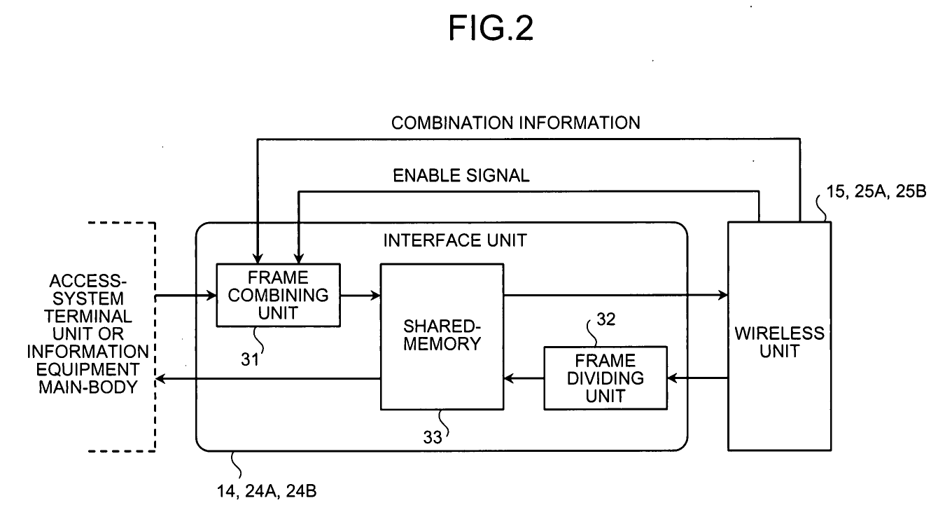

Characteristic operations of the base station and the wireless terminals according to a first embodiment of the present invention are explained in detail. FIG. 2 is a schematic of an example of a configuration of interface units 14, 24A, and 24B of the base station and the wireless terminals according to the present invention. A frame combining unit 31 combines a plurality of frames from the access-system terminal unit 13 of the base station 1 or the information equipment main-body 21A or 21B of the wireless terminal 2A or 2B as appropriate, and stores it in the Shared-Memory 33 in a predetermined format. From the wireless units 15, 25A, and 25B, “combination information for determining a maximum number of combinations or a maximum frame length according to usable radio band and modulation method” and “Enable signal for indicating that a combining is possible” are informed.

A frame dividing unit 32 divides a received frame from the wireless unit 15 of the base station 1 or the wireless unit 25A or 25B of the wireless terminals 2A or 2B into a plurality of frames as appropriate, and stores it in the Shared-Memory 33 in a predetermined format.

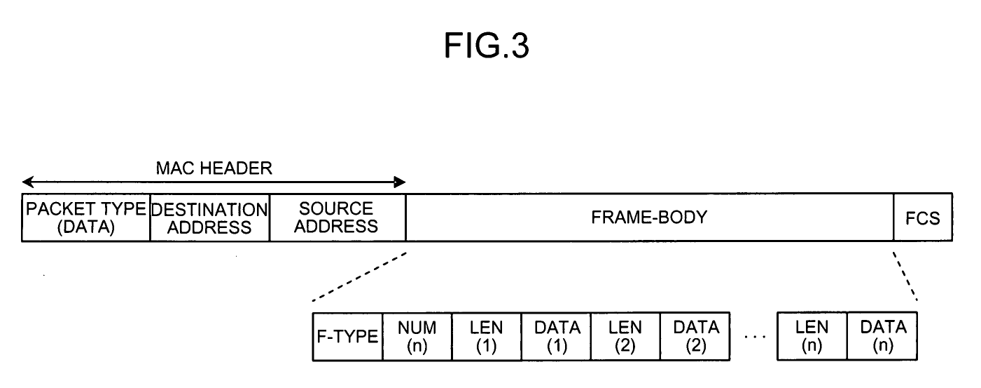

FIG. 3 is a schematic of a data frame format to be transmitted by the wireless unit 15 or the wireless unit 25A or 25B when the frames are combined. This data frame contains a media-access-control (MAC) header containing a packet type field that indicates that the packet is DATA, a destination MAC address, a source MAC address, etc., a Frame-Body that indicates transmitting data, and calculation results (FCS: Frame Check Sequence) for checking bit errors in each packet. Inside the Frame-Body, an F-TYPE field that indicates whether frames are combined, a Num field that indicates the number of combined frames, DATA fields corresponding to the number indicated by the Num field, and a LENGTH field that indicates the DATA field length, and so on are contained. In the data frame format of FIG. 3, detailed fields according to IEEE802.11 and fields to be commonly added to the respective radio packets depending on the modulation method are omitted for convenience of explanation.

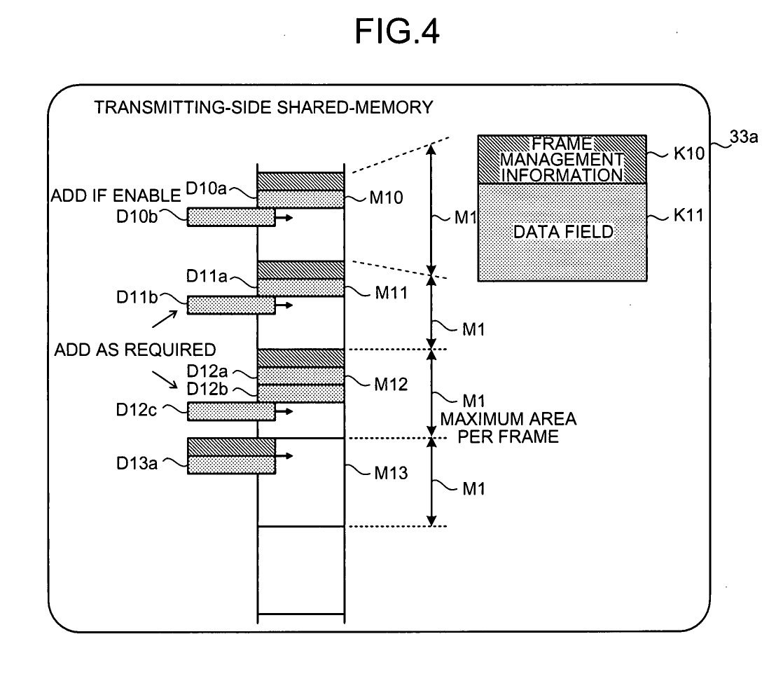

A processing of the frame combining unit 31 according to the first embodiment is explained in detail with reference to the accompanying drawings. FIG. 4 is a schematic of an example of a transmitting-side Shared-Memory 33a in the Shared-Memory 33 according to the first embodiment. The transmitting-side Shared-Memory 33a is divided by a predetermined size M1, and in each of the areas M10 (the head frame after being combined: the next transmitting frame), M11 (the second frame), M12 (the third frame), and M13 (the fourth frame), frame management information K10 containing a frame ID, a destination MAC address, a source MAC address, a number of combinations, a maximum number of combinations, a current frame length, and a maximum frame length, and a data field K11 that can store a plurality of frames are contained. In the respective data fields, for example, frames D10a, D10b, D11a, D11b, D12a, D12b, D12c, and D13a from the access-system terminal unit 13 of the base station 1 or the information equipment main-body 21A or 21B of the wireless terminal 2A or 2B are contained.

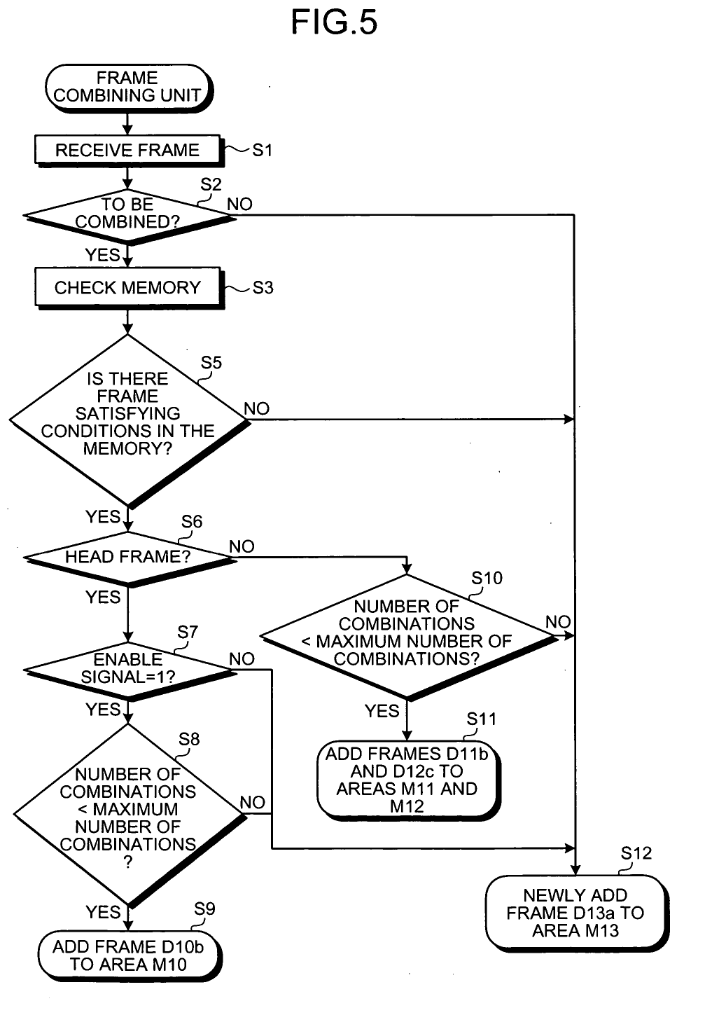

FIG. 5 is a flowchart of a processing procedure for the frame combining unit 31. A frame combination processing using combination information and an Enable signal is explained, as an example, by assuming that the next transmitting packet in the wireless unit 15 (or 25A, 25B) has been stored in the area M10 of the transmitting-side Shared-Memory 33a of FIG. 4. For convenience of explanation, a processing of the frame combining unit 31 of the base station 1 is explained. The frame combining units 31 of the wireless terminals 2A and 2B operate in a similar manner.

In the frame combining unit 31, for example, when a frame from the access-system terminal unit 13 is received (Step S1), inspection information contained in the frame is inspected to determine whether the received frame is to be combined (Step S2). As a result of the inspection, for example, when frame combining is not carried out (Step S2=No), the received frame is stored in the transmitting-side Shared-Memory 33a as a new frame together with the frame management information (Step S12). As shown in FIG. 4, the frame D13a is stored in the area M13 of the transmitting-side Shared-Memory 33a together with the frame management information. As the inspection information, for example, the MAC address, the Internet-protocol (IP) address, the transmission-control-protocol (TCP) port number, the type-of-service (TOS) field (field for describing the degree of packet priority), etc., are used. Depending on conditions, different conditions can be set for the individual MAC address, IP address, and TCP port number, etc.

As a result of the inspection of Step 2, when frame combining is carried out (“YES” at Step S2), in the frame combining unit 31, the transmitting-side Shared-Memory 33a is inspected (Step S3), and it is determined whether a frame that satisfies the conditions is present in the transmitting-side Shared-Memory 33a (Step S5). As a result of determination, when no frame satisfying the conditions is present in the transmitting-side Shared-Memory 33a (“NO” at Step S5), as described above, the received frame is stored in the transmitting-side Shared-Memory 33a as a new frame together with frame management information (Step S12).

On the other hand, when a frame satisfying the conditions is present in the transmitting-side Shared-Memory 33a (“YES” at Step S5), in the frame combining unit 31, it is inspected whether the frame being present in the transmitting-side Shared-Memory 33a is a frame that forms the head frame (area M10) (Step S6). When the frame does not form the head frame (“NO” at Step S6), it is inspected whether the current number of combinations exceeds the maximum number of combinations determined based on combination information (Step S10). When a combining is possible (“YES” at Step S10), the received frame is combined to the rear of the existing frame (Step S11). As shown in FIG. 4, the frame D11b is stored in the rear of D11a of the area M11, and the frame D12c is stored in the rear of D12b of the area M12. On the other hand, when the number of combinations has reached the maximum number of combinations and combining is not possible (“NO” at Step S10), the received frame is stored in the transmitting-side shard memory 33a as a new frame together with frame management information (Step S12).

The maximum number of combinations is determined within the frame combining unit 31 according to combination data that is periodically updated from the wireless unit 15, and for example, when a usable radio frequency band is broad, the band is spatially broad by using multiple input multiple output (MIMO), etc., or modulation efficiency is excellent by using multiple modulation or the like, the maximum number of combinations is set to be large, and on the contrary, when a broad radio frequency band and MIMO cannot be used or the propagation status is insufficient and transmission is carried out while lowering the efficiency of the modulation method, the maximum number of combinations is set to be small.

In addition, as a result of the inspection of Step S6, when the frame in the transmitting-side Shared-Memory 33a is a frame forming the head frame (area M10) (“YES” at Step S6), for example, due to a great backoff value, the band being reserved until a predetermined time, or during receiving, the wireless unit 15 of the base station 1 using CSMA as a wireless access method may not be able to access media over a predetermined period. Therefore, in the frame combining unit 31, based on an Enable signal, it is inspected whether further frame combining is possible, that is, whether there is a time to add the frame (Step S7). As a result, when a combining is possible (Enable signal=1) (“YES” at Step S7), it is further inspected whether the current number of combinations exceeds the maximum number of combinations determined based on combination information (Step S8). When the combining is possible (number of combinations<maximum number of combinations) (“YES” at Step S8), the received frame is combined to the rear of the existing frame (Step S9). As shown in FIG. 4, the frame D10b is stored in the rear of the D10a of the area M10.

When there is no time to combine the frame (“NO” at Step S7), or when it is determined that the current number of combinations has reached the maximum number of combinations (“NO” at Step S8), in the frame combining unit 31, as described above, the received frame is stored in the transmitting-side Shared-Memory 33a as a new frame together with frame management information (Step S12).

Thereafter, the transmitting frame that has been written on the transmitting-side Shared-Memory 33a is readout in a transmitting timing determined by the wireless unit 15 of the base station 1, converted into a radio signal based on the IEEE802.11a, IEEE802.11b, and IEEE802.11g standards, etc., standardized based on the wireless LAN standards IEEE802.11, and transmitted from the antenna 12. The frame length of the transmitting frame may not reach the maximum number of combinations of the maximum frame length when it is transmitted.

According to the first embodiment, the maximum number of combinations is used for determination for combining the frame, however, it is also possible that the determination is made based on parameters calculated according to the maximum frame length, or the radio band and the modulation efficiency, etc. The inspection information is not limited to the MAC address, etc., and it may be a TOS field, an IP address, a TCP port number, and the like. Conditions of the maximum number of combinations and the maximum frame length can be set for the individual MAC address, the TOS field, the IP address, the TCP port number, etc. Depending on the application and services, conditions of the maximum number of combinations and the maximum frame length can be changed. The order in the Shared-Memory 33a can also be changed depending on the application and services.

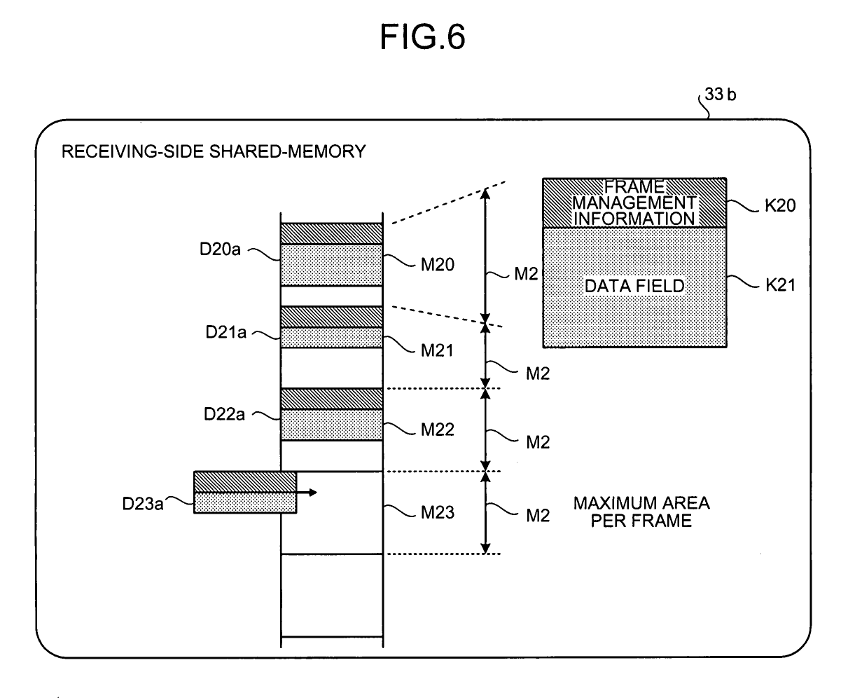

A processing of the frame dividing unit 32 according to the first embodiment is described in detail with reference to the accompanying drawings. FIG. 6 is a schematic of an example of a receiving-side Shared-Memory 33b in the Shared-Memory 33 according to the first embodiment. The receiving-side Shared-Memory 33b is divided by a predetermined size M2, and in each of the areas M20, M21, M22, and M23, frame management information K20 containing a frame ID, a destination MAC address, a source MAC address, etc., and a data field K21 that can store a single frame are contained. In the respective data fields, for example, frames D20a, D21a, D22a, and D23a obtained by dividing the received frame from the wireless unit 15 of the base station 1 or the wireless unit 25A or 25B of the wireless terminal 2A or 2B are contained.

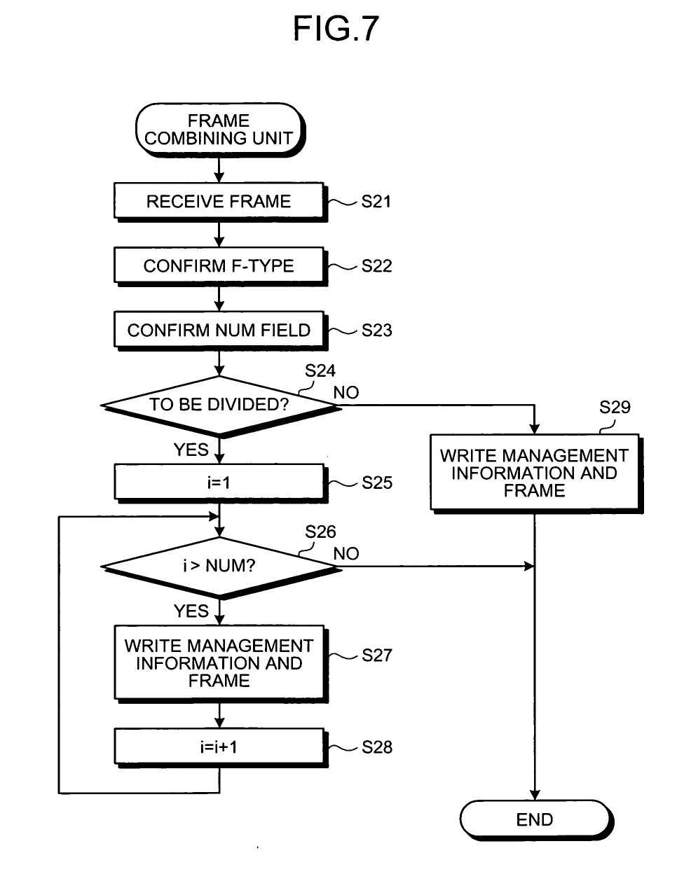

FIG. 7 is a flowchart of a processing procedure for the frame dividing unit 32. A frame dividing processing for the received frame combined like the frame format shown in FIG. 3 is explained as an example. For convenience of explanation, a processing of the frame dividing unit 32 of the base station 1 is explained. The frame dividing units 32 of the wireless terminals 2A and 2B operate in a similar manner.

In the frame dividing unit 32, for example, when a frame is received from the wireless unit 15 (Step 21), to confirm the frame format, an F-type field and a NUM field (see FIG. 3) as inspection information in the frame are extracted (Step S22 and Step S23). As a result, when the frame is a combined frame including the F-type field and the NUM field (“YES” at Step S24), the received frame is determined as a frame to be divided. On the other hand, when the frame does not have the F-type frame and the NUM field, etc., (“NO” at Step S24), the frame dividing unit 32 writes the received frame on the receiving-side Shared-Memory 33b together with the management information (Step S29). For example, management information and the frame D20a are written on the area M20.

As a result of determination at Step S24, when the frame is to be divided (“YES” at Step S24), the frame dividing unit 32 sets an initial value (i=1) (Step S25) and repeatedly carries out writing of the frame management information and the received frame on the receiving-side Shared-Memory 33b a number NUM of times corresponding to the frame combining number (Steps S26, S27, and S28). When NUM=3, the divided first frame D21a is written on the area M21 together with the frame management information, and next, the divided second frame D22a is written on the area M22 together with the frame management information, and last, the divided third frame D23a is written on the area M23.

Thereafter, the received frames written on the receiving-side Shared-Memory 33b are readout from the access-system terminal unit 13 of the base station 1, and processing according to the outside access line is applied.

As described above, according to the first embodiment, the base station 1 and the wireless terminals 2A and 2B forming a home/office wireless network properly combine a plurality of received frames from the outside by using packet information of MAC addresses, IP addresses, TOS fields, etc., and transmit these, and on the receiving-side, the combined frames are properly divided. Thereby, overhead of the header, etc., is reduced, and the proportion of the user data transmitting period to a unit period increases, so that an effective speed according to the broadband of the wireless transmission is obtained and the system throughput is improved.

When the base station 1 and the wireless terminals 2A and 2B using CSMA/CA cannot access media over a predetermined period and there is a time until the next access, received frame combining is continued until the next access timing. Thereby, the idling period between frames for carrier sensing in CSMA/CA and wireless frame response (ACK, NAK) transmitting period can be significantly reduced, so that the system throughput is more improved.

The first embodiment shows a wireless communication system in which wireless terminals are connected to a base station, however, without limiting to this, for example, the present invention is applicable to an ad hoc network in which wireless terminals form an independent network to make communications. The construction inside the interface unit of the first embodiment may be another construction as long as it realizes the frame combining and dividing process. A frame format in a case in which a plurality of received frames are combined is not limited to that of FIG. 3, and may be another construction as long as frame combining processing and dividing processing are realized. The processing according to the first embodiment is applicable to not only CSMA/CA but also wireless access methods of time division multiple access (TDMA), polling, and so on.

### Second Embodiment

A processing of the base station and the wireless terminals according to a second embodiment of the present invention is explained. The construction of the wireless communication system (wireless network for home/office) according to the second embodiment is the same as that of FIG. 1 according to the first embodiment, so that the same symbols are attached and explanation thereof is omitted. The same compositions as those of the interface units 14, 24A, and 24B shown in FIG. 2 are also attached with the same symbols and explanation thereof is omitted. The frame format to be used in the second embodiment is the same as in FIG. 3 according to the first embodiment explained above. Therefore, only processings different from those of the first embodiment are explained.

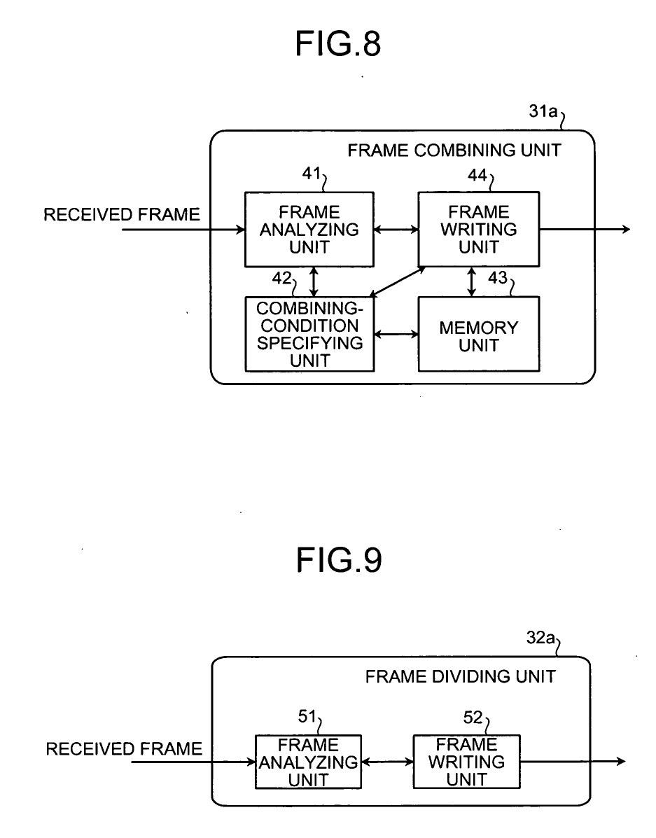

A processing of a frame combining unit 31a according to the second embodiment is explained in detail with reference to the accompanying drawing. FIG. 8 is a schematic of a configuration of the frame combining unit 31a. The frame combining unit 31a includes a frame analyzing unit 41 that analyzes received frames transmitted from the access-system terminal unit 13 of the base station 1 or the information equipment main-body 21A or 21B of the wireless terminal 2A or 2B, a combining condition specifying unit 42 that specifies frame combining conditions, a memory unit 43 that stores a part of information, etc., of the received frame, a frame writing unit 44 that carries out processing of writing the received frames on the Shared-Memory 33 and processing of combining the received frame. Herein, for convenience of explanation, processing of the frame combining unit 31a of the base station 1 is explained, and the frame combining units 31a of the wireless terminals 2A and 2B also operate similarly.

In the frame combining unit 31a, the frame analyzing unit 41 confirms the MAC address, the IP address, the TOS field, and the Real-time Transport Protocol (RTP) field, etc., of the received frame transmitted from the access-system terminal unit 13.

The combining condition specifying unit 42 determines received frame processing by inspecting combining conditions with respect to the MAC address, the IP address, the TOS field, and the RTP field, etc., of the received frame. For example, according to the second embodiment, explanation is given by setting Voice over IP (VoIP) data as a combining condition.

The frame writing unit 44 investigates the memory unit 43 to investigate the way of storing of the previously received frames in the current Shared-Memory 33, confirms the maximum number of combinations and the maximum frame length, etc., and determines processing for the received frame. For example, when no combinable frame is stored in the Shared-Memory 33, the frame writing unit 44 newly stores the received frame in the Shared-Memory 33 by the same processing as in the first embodiment, and further adds the written information to the memory unit 43. When a frame in the Shared-Memory 33 is readout by the wireless unit 15, the contents in the memory unit 43 are also updated.

On the other hand, when the memory unit 43 is investigated and writing on the Shared-Memory 33 is enabled by an Enable signal or combination information conditions, the frame writing unit 44 writes the received frame on a specific point within the Shared-Memory 33 by the same processing as in the first embodiment and combines it.

According to the second embodiment, since the VoIP data is set as a combining condition, the destination MAC address in the data frame format transmitted from the wireless unit 15 is set as a multicast address, and the DATA field inside the Frame-Body contains the MAC address of the received frame.

A processing of a frame dividing unit 32a according to the second embodiment is explained in detail with reference to the accompanying drawing. FIG. 9 is a schematic of a configuration of the frame dividing unit 32a. The frame dividing unit 32a includes a frame analyzing unit 51 that inspects a received frame transmitted from the wireless unit 15 of the base station 1 or the wireless unit 25A or 25B of the wireless terminal 2A or 2B, and a frame writing unit 52 that carries out writing on the Shared-Memory 33 based on the results of analysis. For convenience of explanation, processing of the frame dividing unit 32a of a wireless terminal is explained, and the frame dividing unit 32a of the base station 1 also operates similarly.

The frame analyzing unit 51 inspects the Frame-Body of received frame transmitted from the wireless unit 15, and when it is a frame consisting of a single piece of data, the frame writing unit 52 writes the frame on the Shared-Memory 33.

On the other hand, as a result of the inspection, when a multicast address is written as a destination address and VoIP data containing a plurality of destination MAC addresses is contained in the Frame-Body, the frame analyzing unit 51 extracts only data addressed to its own terminal's MAC address from the Frame-Body, and the frame writing unit 52 writes the extracted data on the Shared-Memory 33.

Thus, according to the second embodiment, a plurality of identical applications are combined, a wireless unit transmits it according to the multicast address, and a receiving-side extracts only data addressed to itself from data received as a multicast address, and writes it on the Shared-Memory. Thereby, frames for a plurality of terminals can be transmitted as one piece of multicast data, and overhead of the wireless access method or the like can be reduced, so that the frame processing delay can be reduced and the system throughput can be improved.

According to the second embodiment, when the VoIP data is used as a combining condition is explained, however, without limiting to this, information such as the TOS field, IP address, TCP port number, can also be used.

### Third Embodiment

A processing of the base station and the wireless terminals according to a third embodiment of the present invention is explained. The construction of the wireless communication system (wireless network for home/office) according to the third embodiment is the same as that of FIG. 1 according to the first embodiment, so that the same symbols are attached and explanation thereof is omitted. The same compositions as those of the interface units 14, 24A, and 24B shown in FIG. 2 are also attached with the same symbols and explanation thereof is omitted. The frame format to be used in the third embodiment is the same as in FIG. 3 according to the first embodiment explained above. Therefore, only processings different from those of the first embodiment are explained.

According to the third embodiment, a construction according to Quality of Service (QoS) using Enhanced Distributed Channel Access (EDCA) regulated by IEEE802.11e is shown. As an example, a model of transmission of QoS data by the base station 1 to the wireless terminal 2A is explained. According to the third embodiment, it is assumed that the Shared-Memory 33 divided by application is provided, and the frame combining unit 31 combines frames for each predetermined application by the same processing as in the embodiments described above.

For example, a frame combined by the frame combining unit 31 is stored in a queue for every priority by the wireless unit 15, and transmitted according to the priorities (EDCA). The wireless unit 15 uses the EDCA method as an example, however, without limiting to this, HCF (Hybrid Coordination Function) Controlled Channel Access (HCCA), Point Coordination Function (PCF), or Distributed Coordination Function (DCF) can be used.

On the other hand, when the combined frame received by the wireless unit 25A has no error, the wireless terminal 2A replies ACK. Then, the received combined frame is divided by the same processing as in the first embodiment or the second embodiment and is transmitted to the information equipment main-body 21A. According to the third embodiment, one ACK may be replied for the combined frame, or ACK may be replied for each of the combined applications.

According to the third embodiment, the Shared-Memory 33 divided by application is provided, and frame combining is carried out on a priority basis. Thereby, frames are transmitted in the order of ascending priorities.

According to the third embodiment, for convenience of explanation, QoS data transmission processing from the base station 1 to the wireless terminal 2A is shown, however, the equipment that carries out the transmission and receiving processing is not limited at all. According to the third embodiment, combined frame transmission on a priority basis is explained, however, without limiting to this, it is also possible that frames with a plurality of applications are combined to one frame based on the priorities and the transmission amounts, and transmitted by multicast. For an application with restriction on the packet delay like streaming data, it is also allowed that combining is carried out only within a permitted period. According to the third embodiment, communications between a base station and wireless terminals are explained, however, without limiting to this, other than the base station, the wireless terminal can make transmission by multicast by containing frames for other wireless terminals belonging to the base station.

According to the third embodiment, in the combining processing of FIG. 5, as frame management information to be stored in the Shared-Memory 33 together with the received frame, QoS information, application information, and restriction information with respect to packet delay are further added.

### Fourth Embodiment

A processing of the base station and the wireless terminals according to a fourth embodiment of the present invention is explained. The construction of the wireless communication system (wireless network for home/office) according to the fourth embodiment is the same as that of FIG. 1 according to the first embodiment, so that the same symbols are attached and explanation thereof is omitted. The same compositions as those of the interface units 14, 24A, and 24B shown in FIG. 2 are also attached with the same symbols and explanation thereof is omitted. The frame format to be used in the fourth embodiment is the same as in FIG. 3 according to the first embodiment explained above. Therefore, only processings different from those of the first embodiment are explained.

The frame combining unit and the frame dividing unit are the same as those in FIG. 8 and FIG. 9 of the second embodiment explained above. Hereinafter, only the processing different from the second embodiment 2 is explained.

According to the fourth embodiment, first, the frame analyzing unit 41 in the frame combining unit 31a at the base station identifies a transmission destination terminal based on an MAC address and an IP address, etc., of a received frame transmitted from the access-system terminal unit 13.

The combining condition specifying unit 42 inspects combining conditions from the transmission destination of the received frame, and determines processing for the received frame. According to the fourth embodiment, for example, a streaming data frame to be multicasted and a polling-controlled unicast data frame are combined together.

The frame writing unit 44 investigates the memory unit 43 to investigate the way of storing of the previously received frames in the current share-memory 33, confirms the maximum number of combinations and the maximum frame length, etc., and determines processing for the received frame. For example, when no combinable frame is present in the Shared-Memory 33, the frame writing unit 44 newly stores the received frames in the Shared-Memory 33 by the same processing as in the first embodiment, and further adds the written information to the memory unit 43. When a frame in the Shared-Memory 33 is readout by the wireless unit 15, the contents of the memory unit 43 are also updated.

On the other hand, when the memory unit 43 is investigated and a combinable frame according to the Enable signal and conditions of the combination information is found in the Shared-Memory 33, the frame writing unit 44 writes the received frame on a specific point within the Shared-Memory 33 and combines it by the same processing as in the first embodiment.

According to the fourth embodiment, when a polling-controlled unicast data frame is contained as a combining condition, one unicast data frame and a plurality of streaming data frames to be multicasted are combined together. On the other hand, when no unicast data frame is contained, only the plurality of streaming data frames to be multicasted are combined. In this case, in a field describing the information of the combined unicast data frame, an IP address and a MAC address of the transmission destination wireless terminal are described.

A processing of the frame dividing unit 32a according to the fourth embodiment is described. For example, in the frame analyzing unit 51 of a wireless terminal, the Frame-Body of a received frame transmitted from the wireless unit 15 is inspected, and when it is a frame consisting of a single piece of data, the frame writing unit 52 writes this frame on the Shared-Memory 33.

As a result of the inspection, a multicast address is written as a destination MAC address and a streaming data frame including a group address of its own terminal is contained in the Frame-Body, the frame writing unit 52 writes this frame on the Shared-Memory 33.

When a data frame being polling-controlled including its own terminal's MAC address as a destination MAC address is contained, the frame analyzing unit 51 extracts only the data addressed to its own terminal in the Frame-Body, and the frame writing unit 52 writes this data on the Shared-Memory 33. Furthermore, a terminal that has received the data frame being polling-controlled replies an ACK frame to the source equipment.

As described above, according to the fourth embodiment, a data frame being polling-controlled and a multicast streaming data are combined together. Thereby, communications can be made with individual terminals while delivering information to the terminals.

According to the fourth embodiment, use of polling control is explained as an example, however, as a control method, DCF, EDCA, or HCCA can also be used in the same manner. The control by priority shown in the third embodiment may be simultaneously performed.

For the base station and the wireless terminals, the construction of FIG. 1 is used, however, communications may be made between base stations or between wireless terminals. Furthermore, according to the fourth embodiment, communications between a base station and wireless terminals are explained, however, other than the base station, the wireless terminal can also transmit frames destined for other wireless terminals belonging to this base station.

### INDUSTRIAL APPLICABILITY

As described above, a base station and a wireless terminal according to the present invention are usable as communications devices to transmit and receive radio signals based on the wireless LAN standards IEEE802.11, and in particular, suitable for a communication system that employs CSMA/CA as a wireless access method.

1-38. (canceled)

39. A base station that makes up a wireless local-area-network system, the base station configured to be connected to an outside access line, the base station comprising:
a combination-information creating unit that creates combination information for determining a maximum number of combinations of frames or a maximum frame length according to a usable radio band and a modulation method and combination possibility information for indicating that a combination of frames is possible, by performing transmission and reception of a radio signal within the wireless local-area-network system;
a frame combining unit that combines a plurality of frames received from the outside access line, based on the combination information, the combination possibility information, and predetermined packet information; and
a frame dividing unit that divides, when the radio signal is received from an information equipment on other side of communication, a combined frame included in a received radio signal, in which a plurality of frames are combined by the information equipment, into individual frames.

40. The base station according to claim 39, wherein
when a frame combinable with a received frame is present, if the combinable frame does not form a head frame after being combined, and if a current number of combinations does not exceed the maximum number of combinations or the maximum frame length determined based on the combination information, the frame combining unit combines the received frame with a rear-end of the combinable frame.

41. The base station according to claim 39, wherein
when a frame combinable with a received frame is present, if the combinable frame forms a head frame after being combined, if the combination possibility information indicates that the combination of frames is possible, and if a current number of combinations does not exceed the maximum number of combinations or the maximum frame length determined based on the combination information, the frame combining unit combines the received frame with a rear-end of the combinable frame.

42. The base station according to claim 39, wherein
when a frame combinable with a received frame is not present, the frame combining unit stores the received frame with frame-combining management information that is predetermined information concerning the combination of frames.

43. The base station according to claim 42, wherein
the frame-combining management information includes at least one of a frame identification, a destination media-access-control address, a source media-access-control address, a current number of combinations or a current frame length, the maximum number of combinations, the maximum frame length, and a value calculated in association with the radio band and the modulation method.

44. The base station according to claim 39, wherein
when a received frame to be divided is detected in the radio signal, the frame dividing unit divides the received frame based on number of frames combined, which is contained in the received frame as information for dividing the frame, and stores divided frames with existing frame management information.

45. The base station according to claim 39, wherein
the predetermined packet information includes a media-access-control address, an Internet-protocol address, a transmission-control-protocol port number, and a type-of-service field.

46. The base station according to claim 45, wherein
different conditions are set for individual pieces of the predetermined packet information.

47. The base station according to claim 39, wherein
the frame combining unit changes the maximum number of combinations or the maximum frame length according to an application and a service.

48. The base station according to claim 39, wherein
the frame combining unit changes an order of transmitting combined frames according to an application and a service.

49. The base station according to claim 39, wherein
when a frame combinable with a received frame is present, if there is time to a next transmission due to a backoff period at a time of carrier-sensing calculated based on a status of use of the radio band, and if a current number of combinations does not exceed the maximum number of combinations or the maximum frame length determined based on the combination information, or a value calculated in association with a radio band and a modulation method, the frame combining unit combines the received frame with a rear-end of the combinable frame.

50. The base station according to claim 39, wherein
the frame combining unit combines frames of a same application with different destinations, and makes it possible to transmit the combined frame by multicast.

51. The base station according to claim 50, wherein
when a combined frame containing the frames with different destinations is received, the frame dividing unit extracts data addressed to the base station.

52. The base station according to claim 39, wherein
the frame combining unit combines frames of different applications or frames with different applications and different destinations, based on quality of service, and makes it possible to transmit the combined frame by multicast.

53. The base station according to claim 52, wherein
when a combined frame containing the frames with different applications or the frames with different applications and different destinations is received, the frame dividing unit extracts data addressed to the base station.

54. The base station according to claim 53, wherein
when the combined frame has no error, an ACK is replied for the combined frame or for each of the applications.

55. The base station according to claim 43, wherein
the frame-combining management information further includes quality-of-service information, application information, and restriction information with respect to a packet delay.

56. The base station according to claim 39, wherein
the frame combining unit combines a unicast data frame with a multicast streaming data frame, and makes it possible to transmit the combined frame by multicast.

57. The base station according to claim 56, wherein
when a combined frame containing the unicast data frame and the multicast streaming data frame is received, the frame dividing unit extracts data addressed to the base station.

58. A wireless terminal that makes up a wireless local-area-network system, the wireless terminal configured to be connected to an information equipment main-body, the wireless terminal comprising:
a combination-information creating unit that creates combination information for determining a maximum number of combinations of frames or a maximum frame length according to a usable radio band and a modulation method and combination possibility information for indicating that a combination of frames is possible, by performing transmission and reception of a radio signal within the wireless local-area-network system;
a frame combining unit that combines a plurality of frames received from the information equipment main-body, based on the combination information, the combination possibility information, and predetermined packet information; and
a frame dividing unit that divides, when the radio signal is received from an information equipment on other side of communication, a combined frame included in a received radio signal, in which a plurality of frames are combined by the information equipment, into individual frames.

59. The wireless terminal according to claim 58, wherein
when a frame combinable with a received frame is present, if the combinable frame does not form a head frame after being combined, and if a current number of combinations does not exceed the maximum number of combinations or the maximum frame length determined based on the combination information, the frame combining unit combines the received frame with a rear-end of the combinable frame.

60. The wireless terminal according to claim 58, wherein
when a frame combinable with a received frame is present, if the combinable frame forms a head frame after being combined, if the combination possibility information indicates that the combination of frames is possible, and if a current number of combinations does not exceed the maximum number of combinations or the maximum frame length determined based on the combination information, the frame combining unit combines the received frame with a rear-end of the combinable frame.

61. The wireless terminal according to claim 58, wherein
when a frame combinable with a received frame is not present, the frame combining unit stores the received frame with frame-combining management information that is predetermined information concerning the combination of frames.

62. The wireless terminal according to claim 61, wherein
the frame-combining management information includes at least one of a frame identification, a destination media-access-control address, a source media-access-control address, a current number of combinations or a current frame length, the maximum number of combinations, the maximum frame length, and a value calculated in association with the radio band and the modulation method.

63. The wireless terminal according to claim 58, wherein
when a received frame to be divided is detected in the radio signal, the frame dividing unit divides the received frame based on number of frames combined, which is contained in the received frame as information for dividing the frame, and stores divided frames with existing frame management information.

64. The wireless terminal according to claim 58, wherein
the predetermined packet information includes a media-access-control address, an Internet-protocol address, a transmission-control-protocol port number, and a type-of-service field.

65. The wireless terminal according to claim 64, wherein
different conditions are set for individual pieces of the predetermined packet information.

66. The wireless terminal according to claim 58, wherein
the frame combining unit changes the maximum number of combinations or the maximum frame length according to an application and a service.

67. The wireless terminal according to claim 58, wherein
the frame combining unit changes an order of transmitting combined frames according to an application and a service.

68. The wireless terminal according to claim 58, wherein
when a frame combinable with a received frame is present, if there is time to a next transmission due to a backoff period at a time of carrier-sensing calculated based on a status of use of the radio band, and if a current number of combinations does not exceed the maximum number of combinations or the maximum frame length determined based on the combination information, or a value calculated in association with a radio band and a modulation method, the frame combining unit combines the received frame with a rear-end of the combinable frame.

69. The wireless terminal according to claim 58, wherein
the frame combining unit combines frames of a same application with different destinations, and makes it possible to transmit the combined frame by multicast.

70. The wireless terminal according to claim 69, wherein
when a combined frame containing the frames with different destinations is received, the frame dividing unit extracts data addressed to the base station.

71. The wireless terminal according to claim 58, wherein
the frame combining unit combines frames of different applications or frames with different applications and different destinations, based on quality of service, and makes it possible to transmit the combined frame by multicast.

72. The wireless terminal according to claim 71, wherein
when a combined frame containing the frames with different applications or the frames with different applications and different destinations is received, the frame dividing unit extracts data addressed to the base station.

73. The wireless terminal according to claim 72, wherein
when the combined frame has no error, an ACK is replied for the combined frame or for each of the applications.

74. The wireless terminal according to claim 62, wherein
the frame-combining management information further includes quality-of-service information, application information, and restriction information with respect to a packet delay.

75. The wireless terminal according to claim 58, wherein
the frame combining unit combines a unicast data frame with a multicast streaming data frame, and makes it possible to transmit the combined frame by multicast.

76. The wireless terminal according to claim 75, wherein
when a combined frame containing the unicast data frame and the multicast streaming data frame is received, the frame dividing unit extracts data addressed to the base station.
